(19) United States
(12) Patent Application Publication
(10) Pub. No.: US 2025/0242891 A1
(43) Pub. Date: Jul. 31, 2025

(54) Watercraft To Minimize Drag Effect

(71) Applicant: Gerald Northcutt, Tehachapi, CA (US)

(72) Inventor: Gerald Northcutt, Tehachapi, CA (US)

(21) Appl. No.: 18/424,821

(22) Filed: Jan. 28, 2024

(51) Int. Cl. B63B 1/38

(52) U.S. Cl. CPC B63B 1/38

(57) ABSTRACT

A watercraft adapted to create or modify a boundary layer during a water ride to reduce dragging effect. The watercraft includes a bow, a stern, a hull bottom, an outboard side, a keel, an inboard side, and a plurality of channels disposed on a wetted area of the hull bottom, wherein the plurality of channels are oriented in an oblique angle from the bow to the stern.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE INVENTION

One or more embodiments of the invention generally relate to watercraft. More particularly, certain embodiments of the invention relate to boundary layer creation and modification on the hulls of watercraft for drag reduction.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. As a boat or other vessel moves through water, the friction between the water and the hull creates a boundary layer that can affect the drag on the boat hull.

FIGS. 1A and 1B illustrate examples of the boundary layer on an airfoil model in a wind tunnel with smoke in the air flow. FIG. 1A shows the airfoil at a low angle of attack, for example, 0 degrees, and FIG. 1B shows the airfoil at a higher angle of attack, for example, 5 degrees. Referring to FIG. 1A in this example, the air flow dynamics of the inviscid region (i.e., the region not affected by viscosity) of the upper surface, or a boundary layer of an airfoil is illustrated. Point A denotes the stagnation point, where the static pressure equals the total pressure and as the flow moves along the upper surface of the airfoil to point B, the flow in the inviscid region gets accelerated with a maximum at point C.

As shown in FIG. 1A the flow area is constantly decreasing from point A to C resulting in decreasing pressure gradient. Since air flows naturally from high to low pressure the flow remains attached. However, when viscosity is involved, a boundary layer forms and separation results. Referring to FIG. 1B, when there is an angle of attack, in this example, 5-degree, separation of airflow is seen downstream. At point D, the airfoil is separated creating a recirculation region which has a high pressure that decreases lift and increases profile drag significantly.

As the angle of attack is increased, the boundary layer on the bottom typically gets even thinner until the angle is so high that the airfoil model “stalls” and provides no lift. All that is left at this point generally is drag on the bottom of the airfoil model because the boundary layer has been crushed to a point where it no longer has any benefit in the way of reducing resistance/drag.

A similar effect exists on a boat hull riding through water. In the process of shearing or separation in the case of the boat hull, one may expect that the drag numbers go way up due to the hull itself shearing the raw water it is riding on, because there is usually no boundary layer assist. On a conventional boat moving in the water there is generally only drag as far as the hull wetted area is concerned. It is believed that, due to the difference in the properties of water versus air, a boundary layer exists, but it is typically so thin that it is of little consequence.

Water generally does not compress or have resilience like air does, and drag is usually a big number especially when a boat exceeds its design hull speed and gets into an area between hull speed, where the majority of the hull wetted area is in intimate contact with the water, and planning speed, where the hull wetted area is greatly reduced due to the planning effect of the hull riding on top of the water rather than in the water as in displacement speeds.

In view of the foregoing, it is clear that these traditional techniques are not perfect and leave room for more optimal approaches.

### BRIEF DESCRIPTION OF DRAWINGS

The present invention is illustrated by way of example, and not by way of limitation, in the figures of the accompanying drawings and in which like reference numerals refer to similar elements and in which:

FIGS. 1A and 1B illustrate examples of the boundary layer on an airfoil model in a wind tunnel with smoke in the air flow in accordance with prior art. FIG. 1A shows the airfoil at a low angle of attack, and FIG. 1B shows the airfoil at a higher angle of attack;

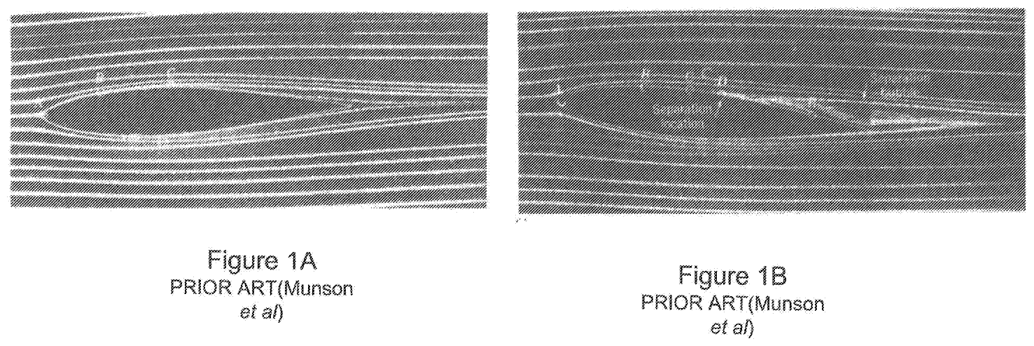

FIG. 2 illustrates the bottom of the boat hull comprising a plurality of channels, in accordance with an embodiment of the present invention;

FIG. 2A illustrates a bottom view of the boat hull;

FIG. 3 illustrates cross sectional views of the profiles of a variety of suitable channels and boundary layer modifying structures, in accordance with embodiments of the present invention.

Unless otherwise indicated illustrations in the figures are not necessarily drawn to scale. least one specification heading is required.

### DETAILED DESCRIPTION OF THE INVENTION

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex Parte Mallory, 52 USPQ 297,297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v.

Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231

USPQ 81, 94 (Fed. Cir. 1986), cert. denied, 480 U.S. 947 (1987). In addition, the use of modifiers in the claim, like “generally” and “substantial,” does not by itselfrender the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747

(B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [” substantially “] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearward most point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof’); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred, or induced by any pattern(s) of description, embodiments, examples, or referenced prior art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them-Such terms are open ended and mean “including but not limited to”. When employed in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to” etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of’ excludes any element, step, or ingredient not specified in the claim. When the phrase “consists of’ (or variations thereof) appears in a clause of the body of a claim, rather than immediately following the preamble, it limits only the element set forth in that clause; other elements are not excluded from the claim as a whole. As used herein, the phase “consisting essentially ot” and “consisting ot” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of’ or “consisting of’ a certain set of elements of any herein described embodiment it shall be understood as obvious by those skilled in the art that the present invention also covers all possible varying scope variants of any described embodiment(s) that are each exclusively (i.e., “consisting essentially of’) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of’ or, alternatively, by “consisting essentially of’, and thus, for the purposes of claim support and construction for “consisting of’ format claims, such replacements operate to create yet other alternative embodiments “consisting essentially of’ only the elements recited in the original “comprising” embodiment to the exclusion of all other elements.

Moreover, any claim limitation phrased in functional limitation terms covered by 35 USC § 112(6) (post AIA 112(£)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s). Furthermore, any statement(s), identification(s), or reference(s) to a structure(s) and/or element(s) that corresponds to and/or supports a claim limitation(s) phrased in functional limitation terms covered by 35 USC § 112(6) (post AIA 112(f)) should be understood to be identified by way of example and not limitation, and as such, should not be interpreted to mean that such recited structure and/or element is/are the only structure(s) and/or element(s) disclosed in this patent application that corresponds to and/or supports such claim limitations phrased in functional limitation terms. This claims interpretation intention also applies to any such subsequent statements made by Applicant during prosecution.

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some preferred embodiments of the present invention describe means for reducing boat hull drag by creating a thicker, more resilient, aerated, turbulent boundary layer under the hull bottom of the boat as the medium against which the hull sheers through. Specific embodiments may comprise channels in or on the hull bottom of a boat or other watercraft for enhancing the boundary layer under the hull. Such embodiments may provide improved operating economy or higher speed of the boat, or both, compared to conventional boat hulls due to drag reduction of the hull shearing the medium on which the boat is operating (i.e., water). One may reason that this can lead to lower cost of operation, more speed, higher efficiency, etc.

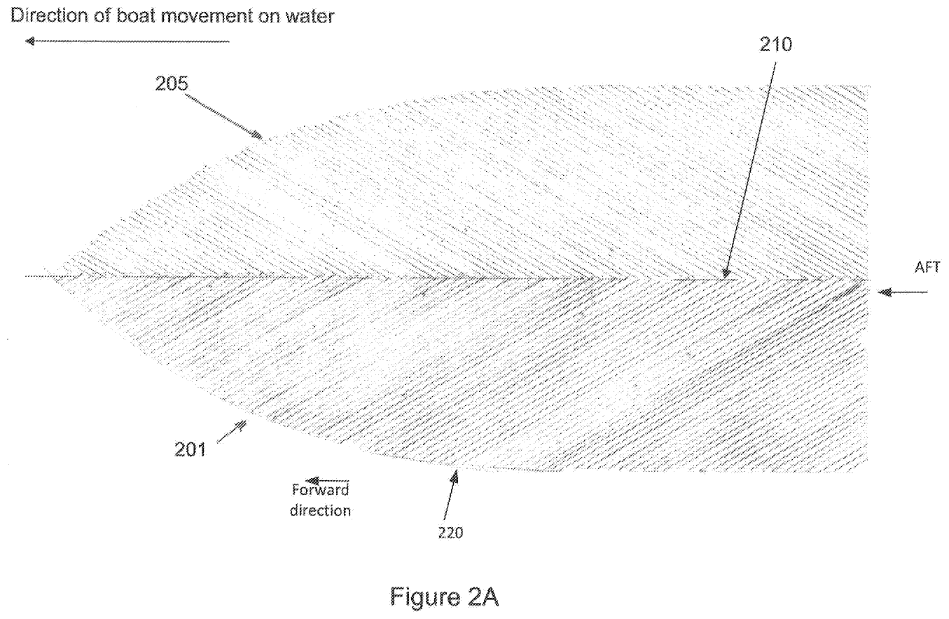

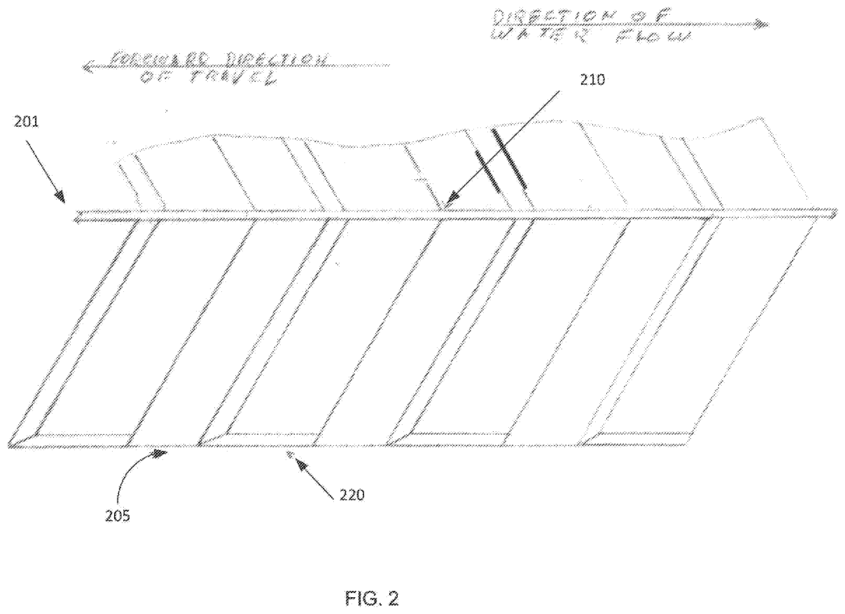

FIG. 2 illustrates the bottom of the boat hull comprising a plurality of channels, in accordance with an embodiment of the present invention. In FIG. 2, boat hull 201 with a plurality of channels 205 is shown. In the present embodiment, channels 205 may be oriented in an oblique angle from the bow to the stem, originating at each side, for example, without limitations, outboard side 220 of the boat hull 201 and terminating near a keel area 210, thereby creating, when the boat is moving thru the water, an area of low pressure in channels 205, which may create turbulence, vortices and bubbles displacing the water flow in contact with the boat bottom in the area of channels

205. Since channels 205 are oriented against the flow of water, one may expect that channels 205 will be to some degree pressurized by inrushing water, adding to the creation of the boundary layer and modification. It is contemplated that this turbulence and displacement of the water flow may result in reducing subsequent drag in the area of channels 205. In addition, some of the turbulence may escape from the channels and further reduce drag on adjacent areas, and any energy left in channels 205 at keel area 210 may serve to crowd underneath the boat reducing drag even more. In alternate embodiments the channels applied to the bottom of a boat hull may be configured in a segmented arrangement to allow for strakes or steps in the hull bottom.

FIG. 2A illustrates a bottom view of boat hull 201. Referring to FIG. 2A, channels 205 may be created in or on the majority of the wetted area (i.e., the portion of the boat under the waterline) of the hull 201 of the boat, oblique to the direction of boat travel. Channels 205 may be disposed in a forward direction along the outboard edges/sides 220 of hull 201 and in an aft direction in inboard areas of hull 201. Alternate embodiments may be configured where the channels are produced or installed from forward inboard at the keel to aft outboard to the side of the boat. The angle of the channels may vary depending on the particular application. A preferred range may include angles between 20° to 30° as oriented against the flow of the water, and a wider range of 0° to 80° may be used in other embodiments.

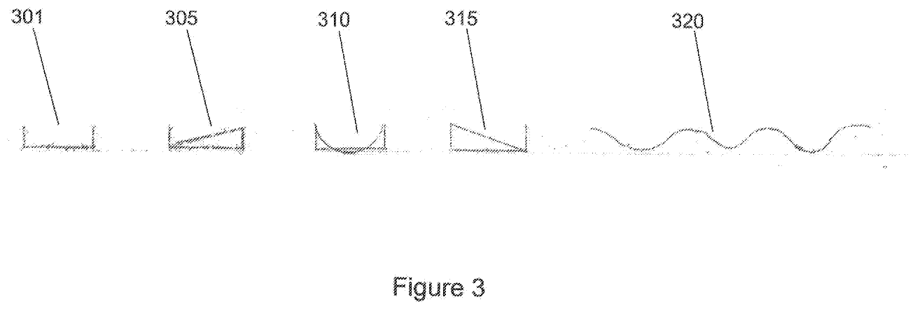

However, alternate embodiments may comprise channels with profiles of various different shapes, for example, without limitation, those shown in FIG. 3. The determination of the size of the channels may depend on multiple factors including, without limitation, the general size of the boat, the length of the boat, beam weight, tonnage, draft, type of hull configuration, etc. Channel size may range from small channels of 0.001″ deep and 0.010″ wide with 0.001″ high walls and 0.010″ separation to much bigger channels, such as, without limitations, 1″ deep and 30″ wide with a separation of 60″ for vessels like large cargo ships, and all dimensions in between. An example of dimensions that would fall into an average range for a typical boat application would be a channel size of 0.030″ deep i.e., 30 thousandths of an inch and 0.250″ wide i.e., two hundred and fifty thousandths of an inch or a ¼ inch with a separation of 0.250″ Another example of channel size would be that of the channels used on a boat used for testing an embodiment of the present invention. The depth of the channels used on an exemplary test boat was 0.005″ with a width of 0.250″ and front and rear edge angles of 90° in relation to the bottom of the channels. Those skilled in the art will readily recognize that the size of the channels can vary greatly from one application to another, and as previously noted, hull weight, shape, speed, beam, length, etc. are major factors in determining the optimum channel configuration for each application.

FIG. 3 illustrates cross sectional views of the profiles of a variety of suitable channels and boundary layer modifying structures, in accordance with embodiments of the present invention. A channel 301 comprises a flat bottom and front and rear walls that are perpendicular to the bottom of the channel. Channels 305 and 315 each comprise an angled bottom going from the surface of the boat hull to the top of a perpendicular wall of the channel to create a wedge-shaped channel. Wedge shaped channels such as, but not limited to, channel 305 and a channel 315 may be configured with various angles. Furthermore, the angle of the walls in the examples shown are primarily directed toward embodiments with walls perpendicular to the surface of the hull. However, it is contemplated that the walls of the channels may be configured at various angles. A channel 310 comprises a curved bottom. A channeled structure 320 comprises a wavy configuration, sinusoidal in nature. Those skilled in the art will readily recognize that a multiplicity of suitable configurations of channels and structures may be implemented in alternate embodiments with walls and bottoms that qualify to be called channels, grooves, ridges, etc. For example, without limitation, a wavy series of channels similar to a washboard could be used. Some embodiments could use grooves configured as Vs or notches with a sloping floor to aft, a dimpled surface like a golf ball, channels shaped like a modified NACA inlet duct or a modified wheeler vortex generator, grooves laid out in a serpentine pattern, etc. Some embodiments may also comprise L-shaped fences on each side of the bottom in an effort to hold turbulent water under the boat. In yet other embodiments, the channels may comprise closed ends rather than open ends. Other embodiments may also allow for longitudinal strakes or steps to be created in the hull by installing the channels in segments rather than continuously.

A preferred method of creating channels is to use a specialized paint roller to apply a medium onto a boat hull in the desired configuration for the channels. For channels of smaller depth, paint, or a similar substance such as, but not limited to an epoxy or fiberglass resin may be used as the medium. Alternately, the channels may be incorporated into a boat hull mold to mold channels into an original hull. It is contemplated that a multiplicity of suitable manufacturing approaches may be used to achieve the channels in a boat hull including, without limitation, using a router, saw, grinder, laser or sandblaster to create channels in an existing hull; gluing strips to the bottom of a hull with adhesives; attaching materials to the hull to create channels using various other methods; applying adhesive backed strips of plastic or other material to the boat hull; using a roller or squeegee to apply a material to be cured with a UV process to the bottom of a boat hull; using adhesive backed tape or a mask to create the channels.

In typical use of embodiments of the present invention, as the boat is moving forward on water, the water is in intimate contact with the boat hull bottom and consequently the water moves across as well as into the channels, low pressure occurs in the channels, turbulence and vortices occur, aeration occurs, micro-bubbles are created, and a mix of micro-bubble aeration and turbulence escape rearward from the channels and are forced out onto the load bearing surfaces of the hull bottom wetted area supporting the boat on the water. The micro-bubble aeration and turbulence may act as lubricated bearings in the boundary layer. Additionally, it is believed that the boundary layer between the hull and the water the boat is riding on is thicker and more resilient than boundary layers created by smooth hulled boats, thereby reducing drag resistance, and increasing efficiency by providing a lower resistance medium for the hull to shear against. Moreover, any unspent energy of micro-bubble aeration and turbulence left over at the inboard bottom of the channels at the keel area may act to support the keel area even more and tend to unload other areas of the hull wetted area adding to the overall efficiency. It is well known to those skilled in the art that a boat can go faster on a choppy surface compared to a calm surface, the turbulent boundary later created by embodiments of the present invention can provide this effect when the boat is underway and at all speeds and with all hull shapes and in various water conditions. In addition, the channels or other boundary layer modification means may provide the means to trap bubbles, vortices, and turbulence while the boat is underway. These effects may lead to increased efficiency equating to more economy or speed or both. It is further believed that channeled hull designs according to embodiments of the present invention typically have little to no stability problems and no need for a stepped hull at higher speed due to the plurality of channels being disposed strategically to most of the wetted area of the hull surface to reduce drag at all speeds. Design and performance variations over a sampling of vessels including, without limitation, jet skis, smaller pleasure craft, speed boats, etc. have shown greater fuel economy and the ability to achieve top speeds more easily. It is believed that large yachts, cruise ships, bulk carriers, etc. will enjoy greater fuel economy as well. Another benefit to all categories is the possibility of passive bottom cleaning while underway due to the aeration and turbulence created under the vessel. It is contemplated that embodiments of the present invention may be configured for use in applications other than boats and other watercraft such as, but not limited to, aircraft, wind turbine blades, re-entry from space vehicles, steam turbines, golf clubs, etc.

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

It is noted that according to USA law 35 USC § 112(1), all claims must be supported by sufficient disclosure in the present patent specification, and any material known to those skilled in the art need not be explicitly disclosed. However, 35 USC § 112(6) requires that structures corresponding to functional limitations interpreted under 35 USC § 112(6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112(6). Applicant(s) note that all the identified documents above which are incorporated by reference to satisfy 35 USC § 112(6) necessarily have a filing and/or publication date prior to that of the instant application, and thus are valid prior documents to incorporated by reference in the instant application.

Having fully described at least one embodiment of the present invention, other equivalent or alternative methods of implementing boundary layer creation and modification on boat hulls for drag reduction according to the present invention will be apparent to those skilled in the art. Various aspects of the invention have been described above by way of illustration, and the specific embodiments disclosed are not intended to limit the invention to the particular forms disclosed. The particular implementation of the boundary layer creation and modification means may vary depending upon the particular context or application. By way of example, and not limitation, the boundary layer creation and modification means described in the foregoing were principally directed to motorized implementations; however, similar techniques may instead be applied to wind and human powered crafts, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AJA. Otherwise, no limitations from the specification are to be read into any claims, unless those limitations are expressly included in the claims.

1. A watercraft, said watercraft comprising:
a bow, a stern, a hull bottom, an outboard side, a keel, and an inboard side; and
a plurality of channels disposed on a wetted area of the hull bottom.

2. The watercraft of claim 1, wherein the plurality of channels disposed on the wetted area of the hull bottom are oriented in an oblique angle from the bow to the stern.

3. The watercraft of claim 2, wherein the plurality of channels originates from the outboard side and terminate in the keel.

4. The watercraft of claim 2, wherein each of the plurality of channels are oriented at an angle in the range of 20° to 30°.

5. The watercraft of claim 1, wherein the plurality of channels may be disposed in a forward direction along the outboard side and in an aft direction in the inboard side.

6. The watercraft of claim 1, wherein each channel of the plurality of channels comprises a flat bottom with a front wall perpendicular to the bottom of the channel and a rear wall perpendicular to the bottom of the channel.

7. The watercraft of claim 1, wherein each channel of the plurality of channels comprises a flat bottom with a front wall perpendicular to the bottom of the channel and a rear wall angled to the bottom of the channel to form a wedge shape.

8. The watercraft of claim 1, wherein each channel of the plurality of channels comprises a flat bottom with the front and rear walls at different angles.

9. The watercraft of claim 1, wherein each channel of the plurality of channels comprises a wavy configuration.

10. The watercraft of claim 1, wherein the size of each channel of the plurality of channels ranges from 0.001 inches to 1 inch depth, 0.010 inches to 30 inches wide and 0.010 inches to 60 inches separation.

11. An apparatus comprising:
a means for creating and modifying a boundary layer under a hull of a watercraft, wherein said means is oriented in an oblique angle from a bow of the watercraft to a stern of the watercraft.

12. The apparatus of claim 11, wherein said means is oriented against the flow of water.

13. A method comprising the steps of:
disposing a plurality of channels on a wetted area of a hull bottom of a watercraft, wherein said plurality of channels are oriented in an oblique angle from a bow to a stern of the watercraft.

14. The method of claim 13, further comprising the step of constructing each channel of said plurality of channels, wherein each channel comprises a flat bottom, a front wall at 90 degrees to the flat bottom, and a rear wall at 90 degrees to the flat bottom.

15. The method of claim 13, further comprising the step of constructing each channel of said plurality of channels, wherein each channel comprises a flat bottom, a front wall at 90 degrees to the flat bottom and a rear wall at 45 degrees to the bottom.

16. The method of claim 13, further comprising the step of constructing each channel of said plurality of channels, where in each channel comprises a flat bottom, a front wall and a rear wall oriented at one or more angles with respect to the flat bottom.

17. The method of claim 13, further comprising the step of constructing each channel of said plurality of channels, wherein each channel comprises a sinusoidal wavy configuration.

18. The method of claim 13, further comprising the step of orienting the plurality of channels at an angle with respect to the flow or water, wherein the angle ranges between 0° to 80°.

19. The method of claim 13, further comprising the step of orienting the plurality of channels at an angle with respect to the flow or water, wherein the angle ranges between 20° to 30°.

20. The method of claim 19, further comprising the step of orienting the plurality of channels against the flow of the water.
